(19) United States
(12) Patent Application Publication
(10) Pub. No.: US 2025/0027501 A1
(43) Pub. Date: Jan. 23, 2025

(54) ELECTRIC SUBMERSIBLE PUMP AUTOMATIC DATA DRIVEN SETPOINT MANAGEMENT

(71) Applicant: Baker Hughes Oilfield Operations LLC, Houston, TX (US)

(72) Inventors: Nicholas Christopher Styles, Cypress, TX (US); Franklin Rodrigo Curay Campoverde, Tulsa, OK (US); Babak Akbari, Houston, TX (US)

(21) Appl. No.: 18/353,682

(22) Filed: Jul. 17, 2023

(51) Int. Cl. F04D 15/00; E21B 43/12; E21B 47/008; F04D 13/08

(52) U.S. Cl. CPC F04D 15/00; E21B 47/008; F04D 13/086; F04D 15/0066

(57) ABSTRACT

Systems and methods for automatically adapting operation of an electric drive system for an electric submersible pump (ESP). A control system for an electric drive receives live measurements of operating conditions of the ESP as the ESP is operating. The control system calculates adjustments to settings of the electric drive which generates output power that drives the ESP, where the adjustments are calculated based at least in part on the live measurements, and without user intervention. The control system thereby automatically controls the drive to modify the output power provided to the ESP, which in turn controls the operation of the ESP. The adjustments may increase the stability of the ESP's operation, improve the performance of the ESP, and adapt the ESP's operation to changing well conditions.

### BACKGROUND

### Field of the Invention

The invention relates generally to electric motors, and more particularly to systems and methods for automatically controlling an electric motor of an electric submersible pump (ESP) system to adjust equipment setpoints and alter the behavior of the ESP.

### Related Art

Oil and natural gas are often produced by drilling wells into oil reservoirs and then producing the oil and gas from the reservoirs. If there is insufficient pressure in a well to force these fluids out of the well, it may be necessary to use an artificial lift system in order to extract the fluids from the reservoir through the well. A typical artificial lift system employs an electric submersible pump (ESP) which is positioned in a producing zone of the well to pump the fluids out of the well.

An ESP system includes a pump and a motor which is coupled to the pump, where the motor drives the pump to lift fluid out of the well. The operation of the ESP involves many variables, and there are many unknowns that arise between the design of an ESP and the installation and operation of the ESP in the field. A number of the factors affecting the operation may also change over time. It is therefore difficult to establish and adjust setpoints for the operation of the ESP so that the production achieved by the ESP is optimized.

One approach to optimizing operation of an ESP involves creation of a comprehensive physics model (a “digital twin” of the ESP). The physics model can be used to predict the ESP's response and changes in production which result from changes in the operation of the ESP. The physics model can therefore be used to identify the correct setpoints for operation of the ESP. Physics models for ESPs are, however, typically difficult to create due to a lack of data. Additionally, these physics models are difficult to maintain because there is a need for accurate measurements of the flow produced from the ESP system so that the physics models can be calibrated to changing downhole conditions. Further, these measurements usually require well tests that are expensive and infrequent. Still further, unconventional wells such as those which produce from US shale resources are more dynamic in behavior and therefore require more frequent calibration of the physics models.

It would therefore be desirable to provide systems and methods that reduce the cost and complexity of determining parameters for optimizing operation of ESPs, particularly in wells that have rapidly changing conditions and/or unusual behaviors.

### SUMMARY

Embodiments disclosed herein use a control system to automatically adapt operation of an electric drive system for an ESP. The control system receives live measurements of operating conditions of the ESP (which may include ESP motor parameters, well conditions, and the like) as the ESP is operating. The control system calculates adjustments to settings of the electric drive which generates output power that drives the ESP, where the adjustments are calculated based at least in part on the live measurements, and without user intervention. The control system thereby automatically controls the drive to modify the output power provided to the ESP, which in turn controls the operation of the ESP. The adjustments may increase the stability of the ESP's operation, improve the performance of the ESP, and adapt the ESP's operation to changing well conditions.

One embodiment comprises a control system for automatically adapting operation of an electric drive system for an ESP. The control system includes one or more computer processors coupled to one or more data storage devices, where the computer processors are adapted to receive live measurements of operating conditions of the ESP as the ESP is operating. The processors calculate adjustments to settings of an electric drive which generates output power that drives the ESP based at least in part on the live measurements. The processors also do this without user intervention. The control system thereby automatically controls the drive to modify the output power provided to the ESP, which in turn controls the operation of the ESP.

In some embodiments, the computer processors and the data storage devices are integral to the electric drive, while in other embodiments the control system is external to the electric drive. The externally configured control system includes one or more input ports adapted to receive the live measurements from one or more sensors, as well as user input via a user interface. The external control system also includes one or more output ports adapted to be coupled to the electric drive and to convey the setting adjustments to the drive.

In some embodiments, the control system is adapted to determine, based at least in part on the live sensor data, whether the ESP is operating in a stable manner. In response to determining that the ESP is not operating in a stable manner, the control system makes corrective adjustments to one or more settings that affect the stability of the ESP's operation. Later, at configurable intervals, re-determines whether the ESP is operating in a stable manner and can make additional corrective adjustments to the settings affecting the stability of the ESP until it operates in a stable manner. In response to determining that the ESP system is operating in a stable manner, the control system may make optimizing adjustments to one or more settings that affect performance of the ESP. The control system may determine performance improvements resulting from the optimizing adjustments, and it may make additional optimizing adjustments to the settings affecting performance of the ESP until no further performance improvement results from the additional optimizing adjustments.

In some embodiments, the control system is adapted to, in a startup stage of operation, receive user input defining one or more initial settings of the electric drive, and begin operation of the electric drive using the initial settings. Then, in a post-startup stage of operation, the control system receives live measurements of the ESP operating conditions and calculates the adjustments to the settings of the electric drive to adjust the operation of the drive to adapt to the changing ESP operating conditions.

In some embodiments, the control system accepts user input indicating an ESP operating mode and a set of parameters associated with the indicated ESP operating mode. The control system's data storage devices may be adapted to store default parameters for one or more selectable ESP operating modes, where the control system retrieves a set of default parameters for a selected one of the ESP operating modes and then provides the selected ESP operating mode and the corresponding set of default parameters to the electric drive.

In some embodiments, the control system is adapted to calculate the adjustments to the settings of the electric drive in response to detecting a change in the operating conditions of the ESP as indicated by the live measurements. The control system may be adapted to automatically adjust the settings of the electric drive at configurable intervals. The control system may also be adapted to generate a notification that is presented to a user in response to detecting a change in the operating conditions of the ESP as indicated by the live measurements.

An alternative embodiment may comprise a method for automatically adapting operation of an electric drive for an ESP. The method includes receiving, at a control system for an electric drive of an ESP, live sensor data for operating conditions of the ESP and automatically adjusting one or more settings of the electric drive based at least in part on the live sensor data without intervention of a user. The method may also include the control system determining, based at least in part on the live sensor data, whether the ESP is operating in a stable manner and making corrective adjustments to one or more settings affecting stability of the ESP in response to determining that the ESP is not operating in a stable manner. The control system may include thereafter re-determining whether the ESP is operating in a stable manner at configurable intervals.

In some embodiments, the method includes repeatedly making corrective adjustments to the settings affecting stability of the ESP until the ESP is operating in a stable manner. The method may also include, in response to determining that the ESP system is operating in a stable manner, making optimizing adjustments to one or more settings affecting performance of the ESP and determining performance improvements resulting from the adjusting. The method may further include repeating the optimizing adjustments to the settings affecting performance of the ESP until no performance improvement results from making the optimizing adjustments. The method may also include generating notifications that are presented to a user in response to determining that the ESP is not operating in a stable manner. In some embodiments, the method may include automatically adjusting the settings of the electric drive at configurable intervals.

Numerous additional alternative embodiments are also possible.

### BRIEF DESCRIPTION OF THE DRAWINGS

Other objects and advantages of the invention may become apparent upon reading the following detailed description and upon reference to the accompanying drawings.

FIG. 1 is a diagram illustrating some of the primary components of an ESP system.

FIGS. 2A and 2B are diagrams illustrating the conventional control of an ESP.

FIGS. 3A and 3B are diagrams illustrating the automated control of an ESP in accordance with some embodiments.

FIG. 4 is a flow diagram illustrating a high level process implemented by an automated control system to control the operation of a drive for an ESP in accordance with some embodiments.

FIGS. 5A-5C are a set of flow diagrams illustrating the operation of an automated control system for a drive when the drive has begun generating output power to drive an ESP in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### DETAILED DESCRIPTION OF EXEMPLARY EMBODIMENTS

One or more embodiments of the invention are described below. It should be noted that these and any other embodiments described below are exemplary and are intended to be illustrative of the invention rather than limiting.

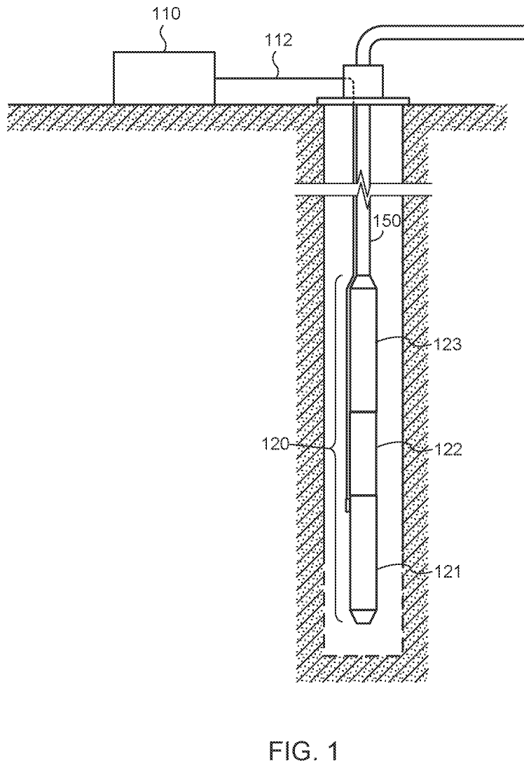

Before describing exemplary embodiments of the invention, it may be helpful to review the overall structure of an ESP. Referring to FIG. 1, a diagram illustrating an exemplary ESP system is shown. In this embodiment, ESP 120 includes a motor section 121, seal section 122, and pump section 123. ESP 120 may include various other components which will not be described in detail here because they are well known in the art and are not important to a discussion of the invention. Motor section 121 is operated to drive pump section 123.

In FIG. 1, ESP system 120 is installed in a well. ESP 120 is coupled to the end of a tubing string 150, and the ESP and tubing string are lowered into the wellbore to position the ESP in a producing portion of the well. ESP 120 is connected to surface equipment which includes a drive system 110. Drive system 110 is coupled to ESP 120 by power cable 112, which runs down the wellbore along tubing string 150 to the ESP. Tubing string 150 and power cable 112 may range from less than one thousand feet in a shallow well, to many thousands of feet in a deeper well.

Drive system 110 may be, for example, a Variable Speed Drive (VSD). Drive system 110 produces power (e.g., three-phase AC power) that is carried via power cable 112 to motor section 121 of the ESP to drive the motor section. The waveform of the output power generated by drive system 110 can be varied to change the operation of motor section 121. Drive system 110 generates the output power based on a number of settings, such as a selected operating mode (e.g., a Proportional-Integral-Derivative (PID) control typically based on motor Amps or intake pressure readings or a fixed output frequency of the power waveform) and a number of setpoint values associated with the selected operating mode.

The output power generated by drive system 110 is provided to motor section 121 of the ESP, driving the motor. As motor section 121 of the ESP is operated, it drives pump section 123, thereby pumping the oil or other fluid through tubing string 150 and out of the well. The efficiency with which the ESP pumps fluids out of the well is dependent upon the well conditions, the motor conditions and the various settings of drive system 110. As the well conditions and motor conditions change, the optimal settings for drive system 110 change, so it is necessary to modify the drive settings to keep the ESP operating optimally. For the purposes of this disclosure, all of these conditions may be referred to collectively as operating conditions of the ESP.

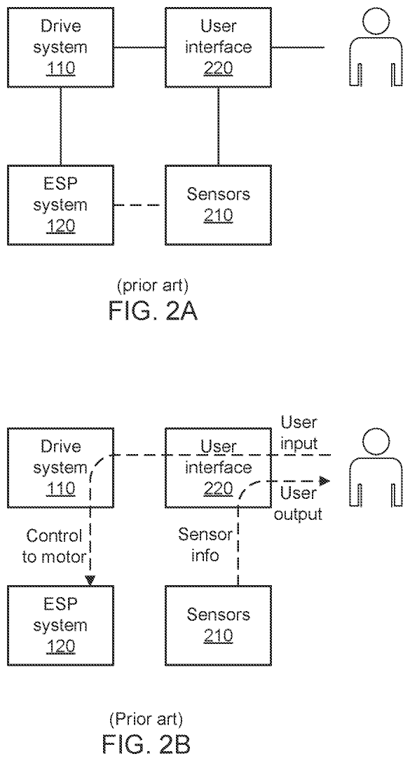

Referring to FIG. 2A, a diagram is shown to illustrate the system components involved in the control of a conventional ESP system. As noted above, drive system 110 is configured to generate output power which is provided to ESP system 120 in order to drive the ESP system. As depicted in this figure, a user interface 220 is connected to drive system 110. User interface 220 allows a user to provide input which configures drive system 110 to generate the appropriate output power for ESP system 120.

A set of sensors 210 is provided to monitor conditions associated with operation of the ESP system. Some of these sensors are configured to monitor well conditions (e.g., temperature, pressure, etc.), while others are configured to monitor parameters associated with ESP system 120 (e.g., motor current, motor temperature, motor speed, pump intake pressure, etc.) Sensors 210 may be positioned in various locations which are advantageous for the particular type of sensor. For example, well pressure will be measured using sensors that are positioned downhole in the well near the ESP system, motor temperature will be measured using sensors that are positioned on the ESP motor, and current sensors may be measured using sensors that are positioned at the output of the drive system. Data generated by sensors 210 is provided to user interface 220, which can display the data to the user.

Referring to FIG. 2B, a diagram is shown to illustrate the control of the conventional ESP system 120. In this diagram, the dashed lines show the flow of information in the system. The user provides input to user interface 220, and this information is used to configure drive system 110. Drive system 110 generates output power according to the information received from user interface 220 it provides this power to ESP system 120 to drive the ESP system. Typically, the user input provided to user interface 220 and drive system 110 includes user selections of a drive mode and associated setpoints. This data controls the output power generated by drive system 110 and thereby controls the operation of the ESP system 120.

While ESP system 120 is operating, sensors 210 monitor conditions associated with the well and the ESP system. This information is transmitted by sensors 210 to user interface 220 so that it can be provided (e.g., displayed) to the user. The sensor data is not conventionally used directly by user interface 220 or drive system 110 to change the operation of ESP system 120. Instead, the information is provided to the user, who manually assesses the information and makes a decision as to whether or not the operation of the ESP system 120 should be modified. The user then manually inputs any changes to the control information (e.g., mode and setpoints) through user interface 220, thereby modifying the control of drive system 110 and ESP system 120.

For example, when a user in the field is operating a conventional ESP system, the user may get information from the drive, such as the motor current and motor frequency, as well as downhole information such as pump intake pressure, discharge pressure and motor temperature. When the user gets this information, they are able to plot the information and see patterns in the information. Based on the patterns the user sees, they can determine from their experience that it may be desirable to switch the drive to a different operating mode. The user can then manually switch the drive to the new mode. The user must also select the appropriate settings for the new control mode. Thus, the user must have the knowledge and experience to recognize the patterns and to identify both the new mode of operation and the proper settings associated with the new mode.

In one scenario, the user may see a pattern that indicates a gas interference or gas lock condition. The user may recognize that an existing pressure control mode for the drive system is not well-suited for the gas interference or gas lock condition. The user may determine that a current control mode is more well-suited to the condition and that a particular value of setpoint for that mode should be set based on the well's stable operation in its recently recorded sensor data. The user makes a change to the mode and settings of the drive system and then observes the performance of the new motor controls and determines further updates to the setpoints again if necessary. This is a manual process and must be repeated over time because wells are so dynamic that only a single instance of applying settings to the drive system typically will not achieve optimal performance of the ESP system.

In another scenario, a gas purge control may be performed. The gas purge control is a is a control routine which is common, in concept at least, to many VSDs which will automatically adjust output frequency of the VSD power in a manner which can aid in freeing a gas locked pump. Even though there may be a pressure control, current control or frequency control which is operable in the system, the ESP may gas lock if there is too much gas in the well. In the case of a gas lock, the user has the option of enabling the gas control to override any current control mode and to enable the gas control in the drive. In response to enabling the gas control to override the control mode, the drive executes a routine in which it slows down the pump speed and then increases the pump speed at predetermined intervals to try to overcome the gas lock. As with the previously described mode changes, the gas purge control is initiated manually by the user in response to recognizing the gas lock condition. Such manually configured control routines, however, may not be effective because often they are not set up correctly, which can result from the settings being out of date due to well conditions having changed.

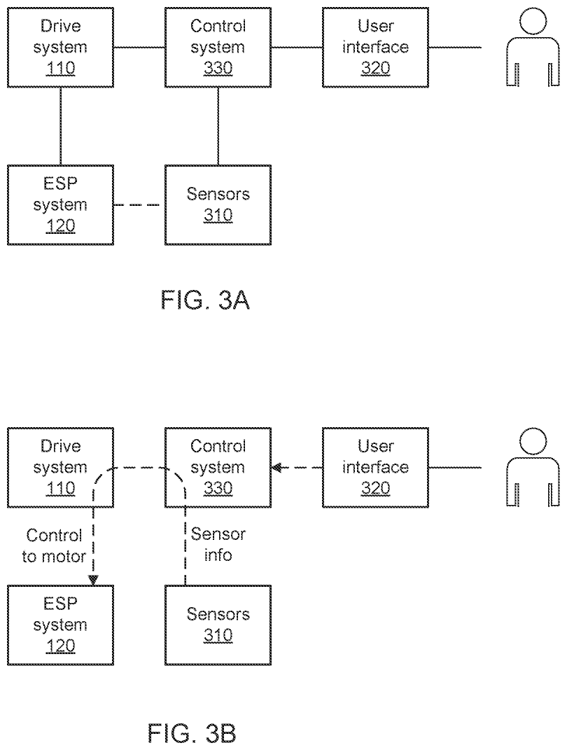

Referring to FIG. 3A, a diagram is shown to illustrate the system components involved in the control of an ESP system in accordance with some embodiments of the present invention. In this system, like the system of FIGS. 2A and 2B, drive 110 is configured to generate output power that is provided to ESP system 120. This drives ESP system 120 to operate and to pump fluid from the well.

The embodiment of FIG. 3A differs from the system of FIGS. 2A and 2B in that it includes an automated control system 330 which is coupled to drive system 110. Control system 330 is also coupled to a user interface 320 through which a user can provide control inputs, such as mode selections and setpoint values. Automated control system 330 also receives data from sensors 310, which may include measurements of ESP system parameters and well conditions. The information input by the user through interface 320 and the information provided by sensors 310 is used by control system 330 to adapt the operation of drive system 110 and ESP system 120 to optimize performance of the ESP system. In some embodiments, the control system may be constructed as a standalone computing system which is configured to be coupled to a separate drive system. This allows conventional drive systems to be retrofitted to have these features. In other embodiments, the control system may be integrated into the drive system.

It should be noted that “optimize,” as used herein, refers to changes which improve the performance of the ESP system, and should not be construed to include only actions which achieve the best possible performance. Thus, while optimizing actions cause the performance of the ESP system to move toward the best possible performance, they do not necessarily achieve that goal.

Referring to FIG. 3B, a diagram is shown to illustrate the manner in which ESP system 120 is controlled in the present embodiments. In this example, a user provides inputs which identify a starting point for operation of drive system 110 and ESP system 120. This input may include, for example, a selected operating mode and a number of setpoints associated with the operating mode. These inputs are provided through user interface 320, and drive system 110 uses the selected mode and setpoints as a starting point to generate the output power that drives ESP system 120.

Once operation of ESP system 120 is initiated, sensors 310 make measurements of the system parameters and well conditions and, rather than simply providing this information to a user as in conventional systems, the sensor information is provided to control system 330. Control system 330 monitors the information received from sensors 310 and uses the sensor information to modify the ESP's operation. If the operation of the ESP system is not stable, the control system modifies the generated output power to try to stabilize its operation. If the ESP's operation is already stable, control system 330 modifies the generated output power to try to improve the performance of the ESP system.

Here, “improving the performance” of the ESP system means increasing the fluid produced by the ESP system. Thus, control system 330 automatically adjusts the operation of the drive system (hence the ESP system) without the intervention of the user, autonomously adjusting the operating parameters of the drive system and ESP system to adapt to changing conditions.

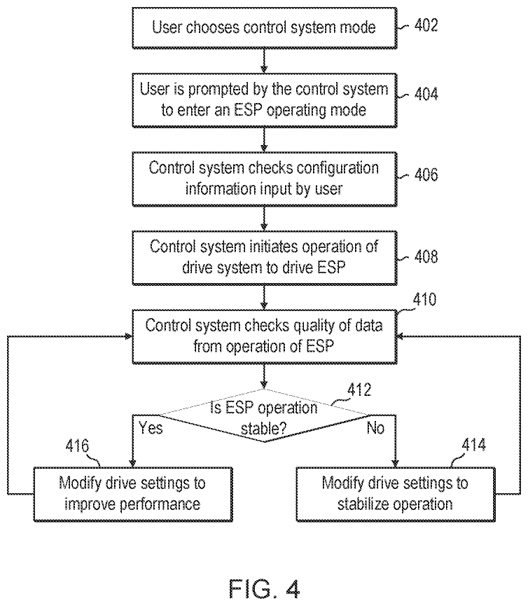

Referring to FIG. 4, a flow diagram is shown to illustrate, at a high level, a process implemented by the control system to control the operation of the drive system and ESP system. Steps 402-406 of this process generally reflect an initialization stage of the process, while steps 408-414 reflect an operating stage of the process during which the control system modifies the operation of the drive system and ESP. It should be noted that since the control system controls the ESP system via the drive system, references herein to controlling the drive system and controlling the ESP system should be construed essentially interchangeably.

At step 402, the control system receives input from the user to select a controller mode. This is the mode of the control system, primarily for initializing the system for operation of the motor. In one embodiment, the controller modes include a simple mode and an advanced mode. These two modes determine how much information is input by the user in the selection of the ESP operating mode.

[Each mode available for selection by the user at this stage represents a higher operational outcome than the typical ESP Controller modes enable. For example, the user can choose a target intake pressure, operating frequency or drawdown (the difference between flowing bottomhole pressure and a predefined reservoir pressure). Still other target operational outcomes are possible. The logic of the control system then manages the operating modes (e.g., set frequency and PID amps/pressure) to achieve the selected target. The control system's ability to manage the control settings to achieve the identified high level target relieves the user of having to deal with the minutia of implementing the controls. In addition to automating the management of the ESP control settings, the control system can do so in real time responsive to live sensor data, and can do so more consistently than a user who must rely on experience and, to some extent, intuition.

At step 404, the user chooses an ESP operating mode. If the user has selected the simple controller mode, the control system will prompt the user to select an ESP operating mode (e.g., target intake pressure mode, target operating frequency mode, target drawdown mode). Once the ESP operating mode is selected by the user, the control system will supply default settings that are associated with the selected mode. In some embodiments, the particular settings that are used as the default settings may be selected based on such information as the equipment type. If the user has chosen the advanced controller mode, the control system will prompt the user to select an ESP operating mode, as well as all of the control settings that are available for the selected mode. In some embodiments, the user is presented with a display of all of the control settings and the user can edit the settings as desired.

The control settings may include various configuration parameters. These may include, for example, time periods between control variable changes, the maximum and/or minimum magnitude of changes over time for control variables, parameters defining analytics behavior (such as those determining stability and time series feature recognition), and variables defining observed well or field characteristics (such as static intake pressure, well geometry and produced fluid properties).

At step 406, after the user has selected the operating mode of the ESP and the settings for the selected mode if necessary, the control system will check the configuration defined by the selected mode and settings to determine whether the configuration approaches any trip setpoints. If the settings approach any trip setpoints, the control system provides a warning to the user that the selected settings are not valid. The user may then be prompted to change the invalid settings so that the operation of the ESP can proceed. If the defined configuration does not approach any trip setpoints, the control system will initiate operation of the drive system using the selected ESP operating mode and associated settings (step 408).

As the drive system and ESP system operate, the ESP motor current is monitored and compared to predetermined operating thresholds which define an acceptable range for operation of the motor (step 410). At step 412, it is determined whether the motor current is within the acceptable range and therefore operating in a stable manner. The stability of the motor's operation may, in some embodiments, be assessed by determining the percentage of time the drive spends at either a high clamp frequency or a low clamp frequency, rather than intermediate frequencies between these two limits. This includes scenarios in which the drive remains at either the high limit or the low limit, as well as scenarios in which the drive abruptly swings back and forth between the high and low limits. If the percentage of time at the high and low limits exceeds a threshold, the operation of the drive is deemed to be unstable.

If the motor operation is not stable, the control system will modify the settings for operation of the system to try to stabilize operation of the motor (step 414). The control system will then check the motor current again to determine whether the operation of the motor has stabilized. This will be repeated until stable operation has been achieved. If operation of the motor cannot be achieved within the predetermined amount of time, the control system may provide a warning to the user, or it may suspend operation of the motor.

if, when the motor current is checked to determine whether it reflects stable operation of the motor (step 412), the motor operation is found to be stable, the control system begins a routine that modifies the control settings of the drive system in an attempts to improve the operation of the ESP system (step 416). This may involve incrementally changing the settings used by the drive system, as well as changing the ESP operating mode used by the system. After modifying the settings to improve performance of the ESP system, the control system returns to step 410.
The control system's attempts to improve performance include determining the suitability of the drive mode. In some embodiments, the control system first determines whether the instability of the motor operation is indicated by (1) the frequency remaining clamped at one of the high or low limits, or (2) swinging back and forth between the limits. As noted above, the instability itself is indicated by the amount of time at the high and/or low limits exceeding a threshold. Whether the instability falls into class (1) or class (2) can be determined using the condition

ABS(LOG(L/H))≤CR_THRES

where L is the number of data points at the low frequency limit, H is the number of data points at the high frequency limit, and CR_THRES is a threshold value. ABS( ) is an absolute value function, and LOG( ) is a logarithmic function. If the condition is satisfied, the instability falls within class (2). Otherwise the instability is within class (1).

If the instability is in class (1), the “objective function” of optimization is too aggressive for the current well conditions. The control system therefore proceeds with the feedback that the current settings are causing excessive system load (resulting in a high frequency clamp) or insufficient system load (resulting in a low frequency clamp). The control system may therefore provide an adjustment to the setpoints in the current control model or a change of the control mode altogether.

If the instability is in class (2), the existing control mode parameters are not suitable for current well conditions, so in a PID mode, basic PID loop parameters (e.g., proportional gain, integral gain, derivative gain, and loop frequency), along with the existing operating conditions, can be adjusted. This may be accomplished in some embodiments using an automated PID tuning workflow.

The control system repeatedly checks the motor current to ensure that the motor operation is stable and that the settings used by the drive system to operate the ESP system are optimized to improve the performance of the ESP system. The control system cycles through the stability checks and performance improvement modifications in order to adapt the settings of the drive system to changing conditions of the ESP system and the well. In some embodiments, the control system may cycle through these checks and updates to the settings at configurable intervals.

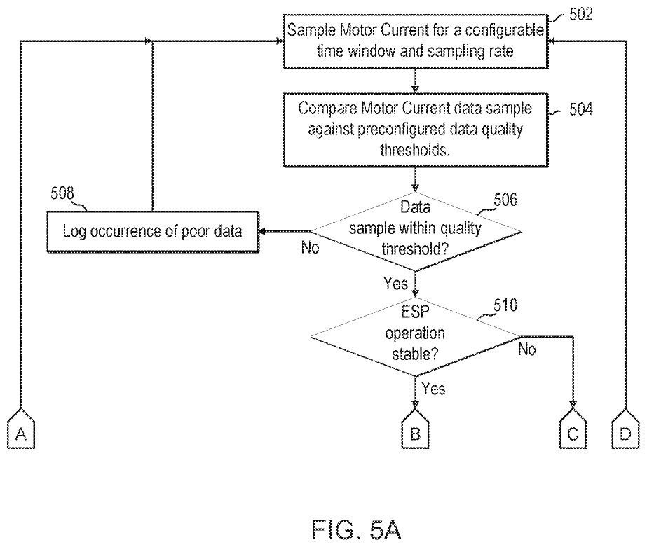

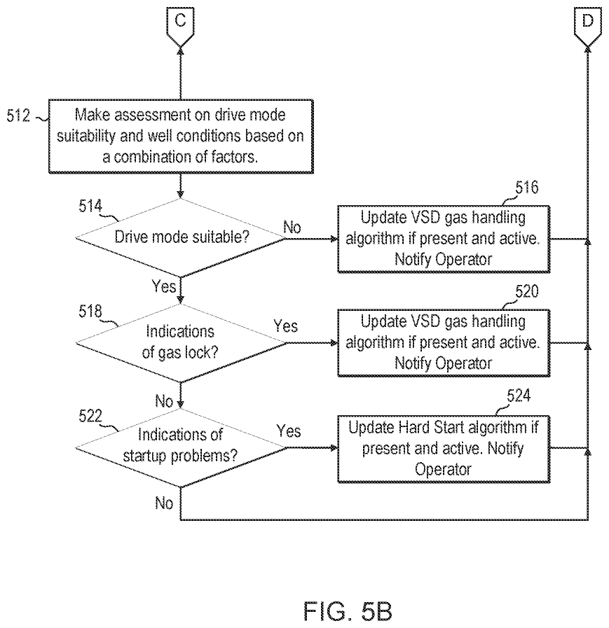

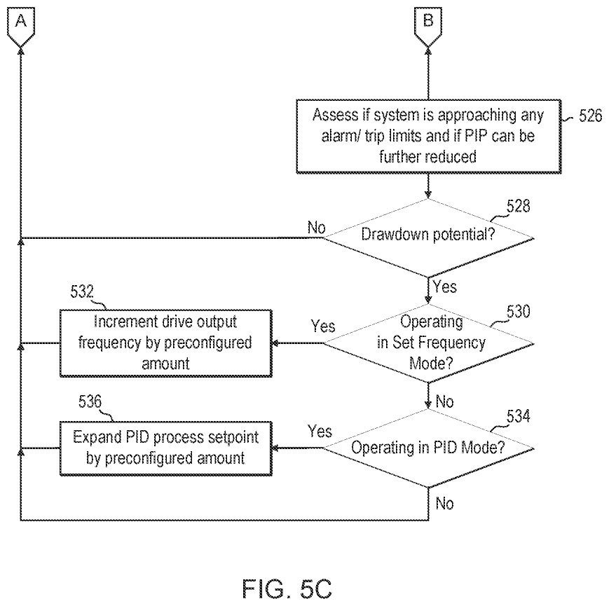

The operation of the control system is shown in more detail in FIGS. 5A-5C. These flow diagrams illustrate the operation of the control system once the drive system has begun generating output power to drive the ESP system.

Referring to FIG. 5A, once the operation of the drive system and ESP system have begun, the control system starts sampling the motor current (step 502). The current may be sampled during a configurable window of time, and may be sampled at a configurable sampling rate. After the motor current has been sampled, the data for the samples is compared to preconfigured data thresholds to determine whether the data meet these quality thresholds (step 504).

If the control system determines at step 506 that the data does not meet the quality thresholds, the occurrence of the low quality data is logged (step 508), and the control system again samples the motor current (step 502) and compares the newly sampled motor current data to the preconfigured thresholds (step 504) to determine whether the new data meets the quality requirements.
if, at step 506, the sampled motor current data is determined to meet the quality thresholds, the control system proceeds to determine whether the operation of the motor is stable (step 510). If the operation of the motor is not stable, the control system begins a procedure to try to stabilize the motor's operation as shown in FIG. 5B. If the operation of the motor is stable, the control system begins a procedure to try to modify the operation of the motor to improve the performance of the ESP system as shown in FIG. 5C. The modification of the operation of the drive system and ESP system are performed by the control system without intervention by the user.

If the control system has determined that the operation of the motor is not stable, the control system will make an assessment of the suitability of the currently selected ESP operating mode and the well conditions (step 512). This assessment may be based on a number of factors, such as time series data, a supplemental physics model or metadata of the ESP and/or well, and well cycling in the history of the well. Time-series data analysis in which the system compares measured sensor data with signatures associated to known problem conditions may be very important. The assessment is based at least in part on live sensor data received by the control system which shows various conditions of the well and ESP system.

If at step 514 the drive mode is determined not to be suitable, the control system changes the ESP operating mode and applies a set of preconfigured settings associated with the new operating mode (step 516). The control system also notifies the operator of the change to the operating mode settings. The control system then returns to step 502 and re-samples the motor current.

If, at step 514, the control system determines that the drive mode is suitable, the control system proceeds to step 518, at which it determines whether or not there are indications of a gas lock. These indications may be driven by a number of factors including number of shutdowns and their duration over a recent time-span. If there is an indication of gas lock, the control system proceeds to step 520, where it updates the gas handling algorithm of the drive system if the algorithm is present and active. Alternatively, the control system may initiate a gas handling algorithm. The user may also be notified of the change regarding the gas handling algorithm. After this update is made, the control system returns to step 502.

If, at step 518, the control system determines that there are no indications of gas lock, the control system proceeds to step 522, at which it makes a determination as to whether there are indications of startup problems. If there are indications of startup problems, the control system proceeds to step 524, at which the control system updates the hard start algorithm if one is present and active. The control system also notifies the user of the hard start algorithm update and/or the startup problems. The control system then returns to step 502.

If the control system has determined that the drive mode is suitable (step 514), that there are no indications of gas lock (step 518), and that there are no indications of startup problems (step 522), the control system simply returns to step 502, where the motor current is sampled again before rechecking the stability of the ESP system (at step 510).

If the control system has determined at step 510 that the operation of the motor is stable, the control system will make an assessment of whether the drive system is approaching any trip points that would trigger an alarm, and whether the target parameter can be further optimized (step 526). At step 528, the control system determines whether there is potential to further exploit the target. If not, the controller returns to step 502 and continues the process of monitoring the motor current and determining the operational stability of the ESP system and the possibility of improving its performance.

If, at step 528, the control system determines that there is potential to optimize operation (i.e., optimize some objective function), it proceeds to determine whether the drive system is operating in a set frequency mode (step 530). If the system is operating in a set frequency mode, the control system proceeds to step 532, and the drive system's output frequency is incremented by a preconfigured amount. The control system then returns to step 502 and continues the process of monitoring the operation of the system.

If, at step 530, the control system determines that the drive system is not operating in a set frequency mode, the control system proceeds to step 534, where the control system determines whether the drive system is operating in a PID mode. If the control system determines that the drive system is operating in a PID mode, the control system proceeds to step 536, where it expands the PID process setpoint by a preconfigured amount. The control system then returns to step 502 and continues the process of monitoring the system's operation. If, at step 534, the control system determines that the drive system is not operating in PID mode, the control system simply returns to step 502 and continues to monitor the drive and ESP systems' operation.

Embodiments of the control systems described above may be implemented using computer systems that include, for example, a computer processor and associated memory. The computer processor may be an integrated circuit for processing instructions, such as, but not limited to a CPU. For example, the processor may comprise one or more cores or micro-cores of a processor. The memory may include volatile memory, non-volatile memory, semi-volatile memory or a combination thereof. The memory, for example, may include RAM, ROM, flash memory, a hard disk drive, a solid-state drive, an optical storage medium (e.g., CD-ROM), or other computer readable memory or combination thereof. The memory may implement a storage hierarchy that includes cache memory, primary memory or secondary memory. In some embodiments, the memory may include storage space on a data storage array.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the described embodiments. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the described embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed by the claims of the application.

What is claimed is:

1. An electric submersible pump (ESP) system comprising:
one or more computer processors coupled to one or more data storage devices;
the computer processors adapted to, during operation of the ESP,
receive live measurements of one or more operating conditions of the ESP, and
calculate, based at least in part on the live measurements and without user intervention, one or more adjustments to one or more settings of an electric drive that generates output power which drives the ESP, thereby controlling the electric drive to modify the output power.

2. The control system of claim 1, wherein the one or more computer processors and the one or more data storage devices are integral to the electric drive.

3. The control system of claim 1, wherein the control system is external to the electric drive, the control system further comprising: one or more input ports adapted to receive the live measurements from one or more corresponding sensors; and one or more output ports adapted to be coupled to the electric drive and to convey the one or more adjustments to the electric drive.

4. The control system of claim 3, the control system further comprising one or more input ports adapted to receive user input defining one or more settings of the electric drive.

5. The control system of claim 1, wherein the control system is adapted to determine, based at least in part on the live sensor data, whether the ESP is operating in a stable manner and, in response to determining that the ESP is not operating in a stable manner, making corrective adjustments to one or more settings affecting stability of the ESP and thereafter re-determining whether the ESP is operating in a stable manner.

6. The control system of claim 5, wherein the control system is adapted to make additional corrective adjustments to the one or more settings affecting stability of the ESP until the ESP is operating in a stable manner.

7. The control system of claim 5, wherein the control system is adapted to, in response to determining that the ESP system is operating in a stable manner, make optimizing adjustments to one or more settings affecting performance of the ESP and determine a performance improvement resulting from the optimizing adjustments.

8. The control system of claim 7, wherein the control system is adapted to make additional optimizing adjustments to the one or more settings affecting performance of the ESP until no performance improvement results from the additional optimizing adjustments.

9. The control system of claim 1, wherein the control system is adapted to:
in a startup stage of operation:
receive user input defining one or more initial settings of the electric drive, and
begin operation of the electric drive using the initial settings; and
in a post-startup stage of operation,
receive the live measurements, and
calculate the one or more adjustments to the one or more settings of the electric drive.

10. The control system of claim 1, wherein the user input indicates an ESP operating mode and a set of parameters associated with the indicated ESP operating mode.

11. The control system of claim 10, wherein the one or more data storage devices are adapted to store default parameters for one or more selectable ESP operating modes, and wherein the control system is adapted to, in response to receiving user input indicating a first one of the ESP operating modes, retrieve a corresponding set of the default parameters, the control system providing the first ESP operating mode and the corresponding set of default parameters to the electric drive.

12. The control system of claim 1, wherein the control system is adapted to calculate the one or more adjustments to the one or more settings of the electric drive in response to detecting a change in the one or more operating conditions of the ESP as indicated by the live measurements.

13. The control system of claim 1, wherein the control system is adapted to, in response to detecting a change in the one or more operating conditions of the ESP as indicated by the live measurements, generate a corresponding notification that is presented to a user.

14. The control system of claim 1, wherein the control system is adapted to automatically adjust the one or more settings of the electric drive at configurable intervals.

15. A method for automatically adapting operation of an electric drive for an electric submersible pump (ESP), the method comprising:
receiving, at a control system for an electric drive of an ESP, live sensor data for operating conditions of the ESP; and
automatically adjusting, by the control system, one or more settings of the electric drive based at least in part on the live sensor data without intervention of a user.

16. The method of claim 15, further comprising determining, by the control system based at least in part on the live sensor data, whether the ESP is operating in a stable manner and, in response to determining that the ESP is not operating in a stable manner, making corrective adjustments to one or more settings affecting stability of the ESP and thereafter re-determining whether the ESP is operating in a stable manner.

17. The method of claim 16, further comprising repeating the making corrective adjustments to the one or more settings affecting stability of the ESP until the ESP is operating in a stable manner.

18. The method of claim 16, further comprising:
in response to determining that the ESP system is operating in a stable manner, making optimizing adjustments to one or more settings affecting performance of the ESP and determining a performance improvement resulting from the adjusting; and
repeating the making optimizing adjustments to the one or more settings affecting performance of the ESP until no performance improvement results from the making optimizing adjustments.

19. The method of claim 16, further comprising generating, in response to determining that the ESP is not operating in a stable manner, one or more corresponding notifications that are presented to a user.

20. The method of claim 15, wherein the control system is adapted to automatically adjust the one or more settings of the electric drive at configurable intervals.
